(19) United States
(12) Patent Application Publication
(10) Pub. No.: US 2016/0090135 A1
(43) Pub. Date: Mar. 31, 2016

(54) Greased Hydraulic Excavator Track Seal Assembly

(71) Applicant: Caterpillar Inc., Peoria, IL (US)

(72) Inventors: Eric Johannsen, Washington, IL (US); Mark Diekevers, Germantown Hills, IL (US)

(73) Assignee: Caterpillar Inc., Peoria, IL (US)

(21) Appl. No.: 14/496,593

(22) Filed: Sep. 25, 2014

(51) Int. Cl. B62D 55/088; B62D 55/21

(52) U.S. Cl. CPC B62D 55/0887; B62D 55/21

(57) ABSTRACT

An example track assembly in accordance with the present disclosure may include a pin, a bushing, a link, and a seal. The pin may define an axis, and may include opposing ends. The bushing may be positioned about the pin, and may include opposing ends. The link may have an inner face extending radially from the axis and defined by at least three portions. The three portions may include a recessed portion disposed between two non-recessed portions. The recessed portion may have a recessed face. The seal may be disposed at least partially within the recessed portion of the link. The seal may engage the recessed face of the link and may engage an end of the bushing such that a gap exists between the inner face of the link and the end of the bushing.

### TECHNICAL FIELD

This disclosure relates generally to a track chain for a track type vehicle, and, more particularly, to a track joint assembly having a seal assembly for use in a joint for relative rotation between links of a track chain.

### BACKGROUND

Track type machines generally have a sprocket, an idler, and a track chain assembly. During use of the machine, the sprocket rotates and engages the track chain assembly, thereby causing the track chain assembly to rotate around a path defined by the sprocket and the idler. The rotation of the track chain assembly causes the machine to be propelled over the ground so as to perform various work functions.

Track chain assemblies generally include a pair of parallel chains, with each parallel chain being made up of a series of track links. Track chain assemblies further include a series of cartridges that include bushings, pins, collars, seals and inserts. The cartridges are interposed between and connected to the links of the parallel chains. The cartridges and the entrained track links cooperate to form a number of track joints which allow the necessary movement of the track links during use of the track chain assembly, for example, when the track chain assembly rotates about the sprocket and the idler.

Over the course of many hours of operation, the constant contact of the moving track chain components can result in significant wear, even where bearings and lubricating oil and grease are used to reduce friction among the components. This wear, however, can lead to component failure, which can lead to leaks of the lubricating oil or grease.

In some instances, such as in U.S. Pat. No. 6,951,373, titled “Crawler belt and seal for use therein,” such wear is purported to be reduced or prevented. However, this solution and other conventional solutions require large seals and/or rings, which add to manufacturing costs. Accordingly, there is a need for improved mechanisms to reduce wear on track chain components.

### SUMMARY

In one aspect, the present disclosure discloses a track assembly having a pin, a bushing, a link, and a seal. The pin may define an axis, and may include first and second opposing ends. The bushing may be positioned about the pin, and may include first and second opposing ends. The link may have an inner face extending radially from the axis and defined by at least three portions. The three portions may include a recessed portion disposed between two non-recessed portions. The recessed portion may have a recessed face. The seal may be disposed at least partially within the recessed portion of the link. The seal may engage the recessed face of the link and may engage the first end of the bushing such that a gap exists between the inner face of the link and the first end of the bushing.

In another aspect, the present disclosure discloses a track assembly including a pin, a bushing, a link, and a seal. The pin my define an axis, and may include first and second opposing ends. The bushing may be at least partially disposed about the pin, and may have an inner face extending radially from the pin. The link may be at least partially disposed about the pin, and may have an inner face extending radially from the pin. The inner face of the link may include a counter bore forming a cavity. The seal assembly may be at least partially disposed in the cavity. The seal assembly may engage the cavity and may engage the inner face of the bushing. The inner face of the link may not engage the inner face of the bushing.

### BRIEF DESCRIPTION OF THE DRAWINGS

FIG. 1 is a side view of an example machine in accordance with at least one embodiment of the present disclosure.

FIG. 2 is a partial sectional view of an example track assembly in accordance with at least one embodiment of the present disclosure.

FIG. 3 is a close-up view of a portion of the partial sectional view of an example track assembly of FIG. 2.

FIG. 4 is a partial sectional view of an example link in accordance with at least one embodiment of the present disclosure.

### DETAILED DESCRIPTION

It should be noted that the methods and systems described herein may be adapted to a large variety of machines. The machine may be any track type vehicle such as a vehicle that performs some type of operation associated with an industry such as mining, construction, farming, transportation, or any other industry known in the art. For example, the machine may be an earth-moving machine, such as an excavator, dozer, wheel loader, dump truck, backhoe, motor grader, material handler, and the like.

Further, it should be noted that the Figures are illustrative only and they are not drawn to scale.

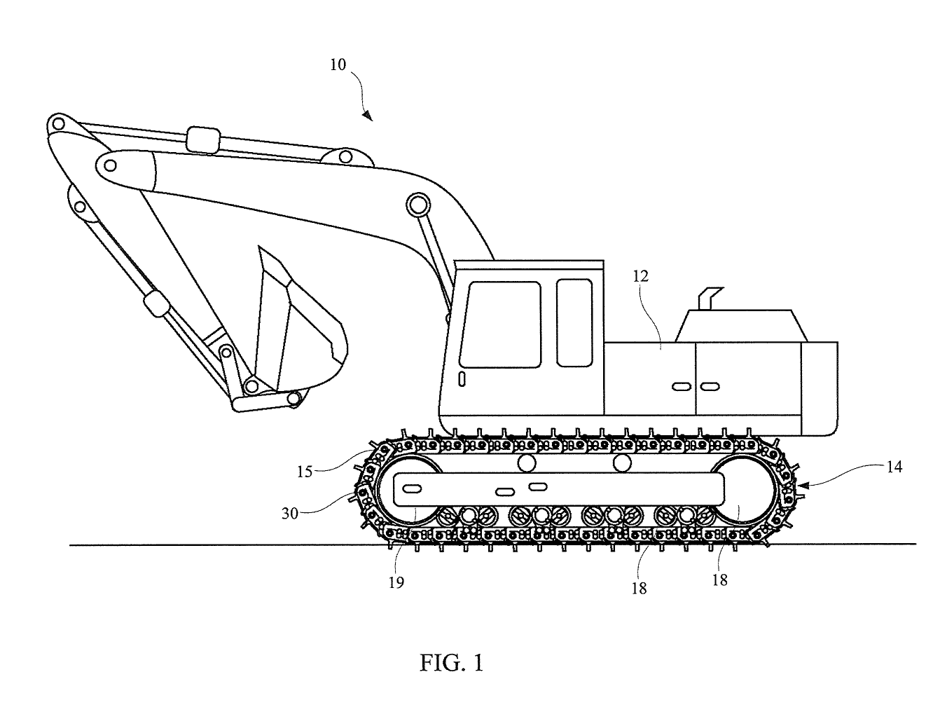

Referring to FIG. 1, there is shown a track type machine 10 according to some examples of the present disclosure. Machine 10 includes a machine body 12. A track chain assembly (or track assembly) 14 extends about a drive sprocket 18 and a front idler 19. Track assembly 14 includes a plurality of links 15, each movably coupled to two others via a cartridge assembly 30. A plurality of track rollers 17 may be coupled with machine body 12 and rotate against track assembly 14 in a conventional manner. Machine 10 may include identical track assemblies and idlers on opposite sides thereof, in a conventional manner. Machine 10 is illustrated as an excavator, however, it should be appreciated that the present disclosure is not thereby limited, and any of a wide variety of track type machines might be designed according to the present disclosure.

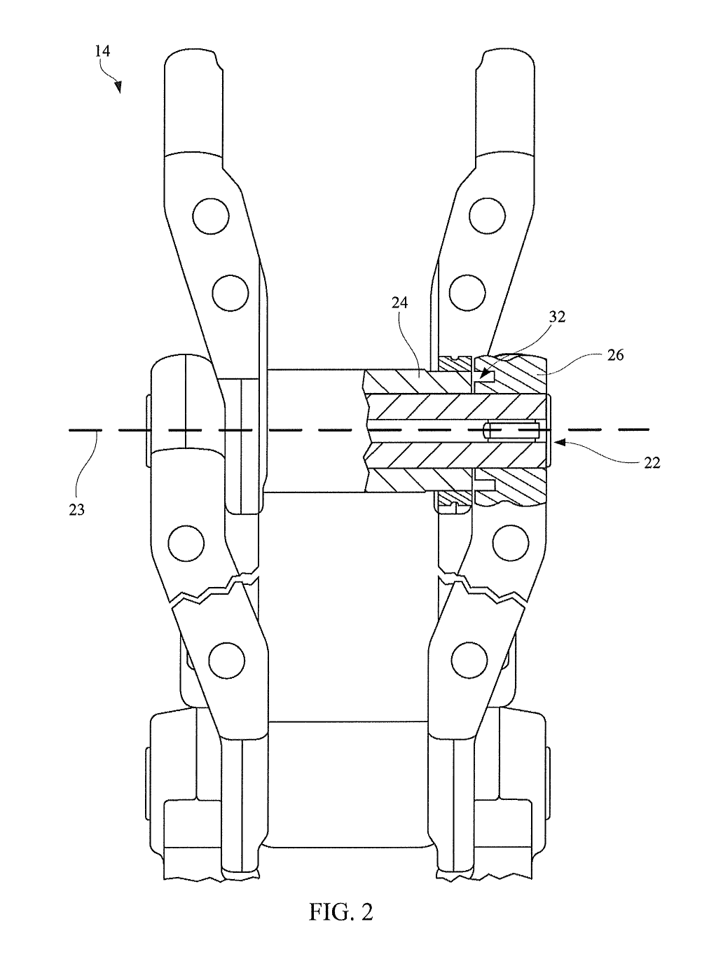

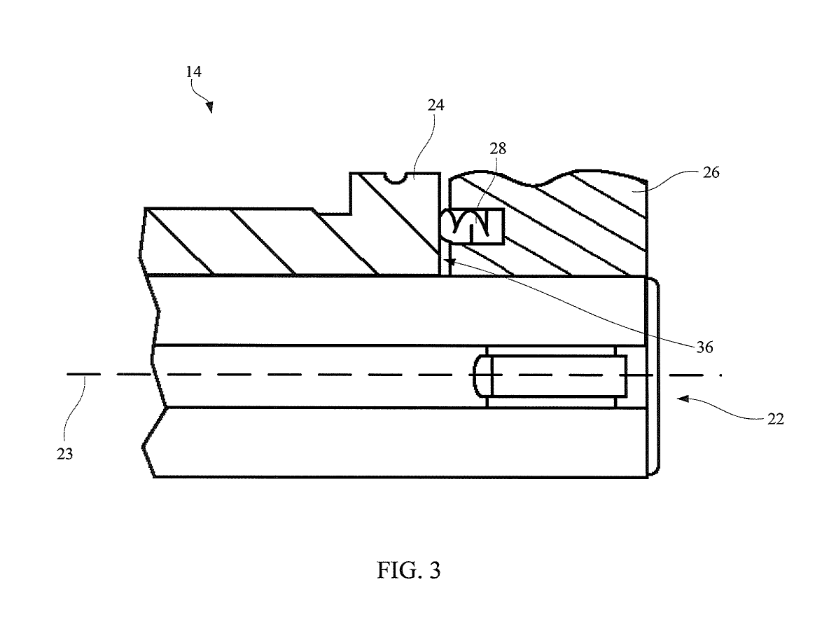

FIG. 2 is a partial sectional view of an example track assembly 14 in accordance with at least one embodiment of the present disclosure. FIG. 3 is a close-up view of a portion of the partial sectional view of an example track assembly 14 of FIG. 2. The track assembly 14 may include a pin 22, a bushing, 24, a link 26, and a seal 28.

A pin 22 may have two opposing ends such that the pin 22 defines an axis 23. The pin 22 may be cylindrical in shape such that other components may rotate relative to the pin 22. The pin 22 may be a conventional pin used in track assemblies, for example. The outer surface of the pin 22 may be at least partially surrounded by a lubricating material (or fluid) to effectuate smooth movement of the pin 22 relative to other components of the track assembly 14. Some example lubricating materials may include grease, natural oil, synthetic oil, or other lubricant known in the art.

The track assembly 14 may also include one of more bushing 24 positioned about and/or around the pin 22. The bushing 22 may have two opposing ends. The bushing 24 may be positioned adjacent the pin 22 such that an inner surface of the bushing 24 may interface with the pin 22 via the lubricating material. The lubricating material may reduce any rotational friction between the bushing 24 and the pin 22, allowing the bushing 24 to rotate freely relative to the pin 22.

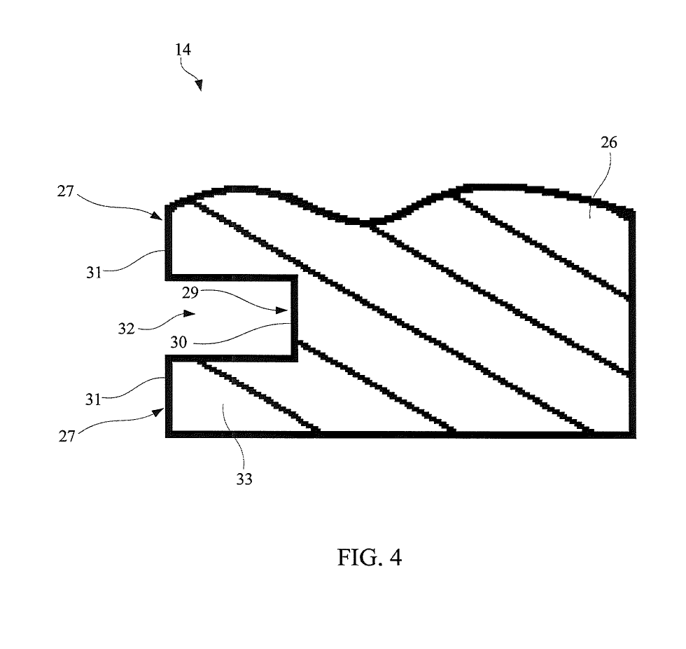

FIG. 4 is partial sectional view of an example link of an example track assembly 14 in accordance with at least one embodiment of the present disclosure. The track assembly 14 may include a link 26 having an inner face 27 extending radially from the axis 23 defined by the pin 22. The inner face 27 of the link 26 may be defined by at least three portions: a recessed portion 30 and two non-recessed portions 31. The recessed portion 30 may be between the two non-recessed portions 31. The non-recessed portion 31 adjacent the pin 22 may form an integral flange 33 of the link 26.

In some examples, the recessed portion 30 may be a counter bore section formed by any conventional counter bore method. In this manner, the recessed portion 30 may form a cavity 32. The recessed portion 30 may be surrounded by the link 26 and the integral flange 33 of the link 26. The recessed portion 30 may have a recessed face 29 that is substantially parallel to the inner face 27 of the link 26. In some examples, the recessed face 29 may be non-linear and/or not substantially parallel to the inner face 2 of the link 26. In some examples, the integral flange 33 may have a height in the range of about 7 millimeters to 12 millimeters (as measured radially from axis 23) and a depth in the range of about 3 millimeters to 6 millimeters (as measured along the axis 23 from the inner face 27 to the recessed face 29).

In some examples, the cavity 32 may have a height in the range of about 6 millimeters to 12 millimeters (as measured radially from axis 23) and a depth in the range of about 6 millimeters to 12 millimeters (as measured along the axis 23 from the inner face 27 to the recessed face 29). Cavity 32 dimensions may vary depending on the type of track assembly 14 and/or other factors. In some examples, the cavities may have square and/or circular cross-sections, which may vary depending on type of track assembly 14 and/or other factors.

The track assembly 14 may also include a seal 28 positioned at least partially within the cavity 32 of the link 26. The seal 28 may engage the recessed face 29 of the link 26 and may engage the end of the bushing 24 adjacent the link 26. Due to the seal's 28 engagement of the link 26 and the bushing 24 may create a gap (or space) 36 between the inner face of the link 26 and the end of the bushing 24. In some examples, the gap 36 may be in the range of 0.1 to 2 millimeters. In some examples, the seal 28 may have a height in the range of about 6 millimeters to 12 millimeters (as measured radially from axis 23) and a length in the range of about 6 millimeters to 12 millimeters (as measured along the axis 23 from the bushing 24 to the recessed face 29). For purposes of clarity, the seal 28 is not shown in the example track assembly 14 in FIG. 2, but the cavity 32 in which the seal 28 may be installed is shown.

In some examples, the seal 28 may include a urethane seal, but any known sealing material may be implemented. In some examples, seal 28 may be a multi-piece track seal, such as a track seal with a polycarbonate base. In some examples, a multi-piece seal may include portions of metal material, polycarbonate material, and/or other known materials.

The gap 36 between the link 26 and the bushing 24 may prevent or limit compression of the integral flange 33. The gap 36 may prevent or reduce overcompression of the seal 28 while allowing relative rotation of the bushing 24 and link 26. In some examples, multiple seals 28 may be used, and in some examples, multiple seals 28 may interact to function as a single seal 28. The present disclosure contemplates that the seal 28 used in some examples may be a smaller seal 28 than conventionally used (which may save on manufacturing costs), but conventional sizes of seals 28 may also be used.

### INDUSTRIAL APPLICABILITY

The industrial applicability of example track assemblies described herein will be readily appreciated from the foregoing discussion.

As a machine travels across a work surface, track will travel along its path, about sprocket and idlers. During use, the track links will rotate relative to one another. To avoid excess wear on the track links, a lubricating material or fluid is usually present within a track assembly. The present disclosure provides a track assembly that may reduce wear on seals and links, thus reducing the potential for leakage of lubricating materials and fluids from within the track assembly. In some examples, the track assemblies of the present disclosure reduce overcompression of the seals. Such overcompression also increases seal wear and potential failure thereof. When the seals wear or fail, they must be replaced or serviced or the entire track assembly must be replaced or serviced.

For example, many hydraulic excavators use a greased track. The grease, however may leak from the track assembly joints within 1,000-2,000 hours (e.g., 15% of life). The present disclosure provides example track assemblies that may extend the amount of time until grease leaks from the track assembly, thus extending the usable life of the track assembly.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

All methods described herein may be performed in any suitable order unless otherwise indicated herein or otherwise clearly contradicted by context.

1. A track assembly, comprising:
a pin defining an axis, the pin including first and second opposing ends;
a bushing positioned about the pin, the bushing including first and second opposing ends;
a link having an inner face extending radially from the axis and including a recessed portion disposed between two non-recessed portions, the recessed portion having a recessed face, wherein one of the non-recessed portions of the inner face of the link engages the pin; and
a seal disposed at least partially within the recessed portion of the link, wherein the seal engages the recessed face of the link and engages the first end of the bushing such that a gap exists between the inner face of the link and the first end of the bushing.

2. The track assembly of claim 1, wherein the gap extends between about 0.1 millimeters and about 2 millimeters.

3. The track assembly of claim 1, wherein the recessed face has a length of between about 6 millimeters and about 12 millimeters.

4. (canceled)

5. The track assembly of claim 1, wherein the recessed face is substantially parallel to the two non-recessed portions.

6. The track assembly of claim 1, wherein the seal comprises at least one of a urethane sealing material, a metal material, and a polycarbonate material.

7. A track assembly, comprising:
a pin defining an axis, the pin including first and second opposing ends;
a bushing at least partially disposed about the pin, the bushing having an inner face extending radially from the pin;
a link at least partially disposed about the pin, the link having an inner face extending radially from the pin, the inner face of the link including a counter bore forming a cavity; and
a seal assembly at least partially disposed in the cavity, the seal assembly engaging the cavity and engaging the inner face of the bushing;
wherein the inner face of the link does not engage the inner face of the bushing.

8. The track assembly of claim 7, wherein the link includes a flange disposed between the cavity and the pin.

9. The track assembly of claim 8, wherein the flange is restricted from engaging the inner face of the bushing due to the seal assembly engagement of the cavity and the inner face of the bushing.

10. The track assembly of claim 7, wherein a space between the inner face of the link and the inner face of the bushing is between about 0.1 millimeters and about 2 millimeter.

11. The track assembly of claim 7, wherein the seal assembly restricts the inner face of the link from engaging the inner face of the bushing.

12. The track assembly of claim 7, wherein the seal extends radially about the axis.
